(19) United States
(12) Patent Application Publication
(10) Pub. No.: US 2017/0169167 A1
(43) Pub. Date: Jun. 15, 2017

(54) Method And Electronic Device For Data Information Processing

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Hongbin LIU, Beijing (CN); Tielong GUO, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/241,292

(22) Filed: Aug. 19, 2016

Related U.S. Application Data
(63) Continuation of application No. PCT/CN2016/088128, filed on Jul. 1, 2016.

(30) Foreign Application Priority Data
Dec. 14, 2015 (CN) 201510927475.X

(51) Int. Cl. G06F 19/00; G06F 17/30

(52) U.S. Cl. CPC G06F 19/322; G06F 17/30303; G06F 17/30867

(57) ABSTRACT

This disclosure relates to a method and device for data information processing. The method may include: acquiring task logic of data processing when the data is under processing; determining input data and output data corresponding to the task logic according to executing logic of the task logic; determining data DNA relation information between the input data and the output data; and establishing, with respect to a plurality of stored data, a data DNA relation network among the plurality of stored data, according to the data DNA relation information of each of the stored data. With such a method, if certain data in the network is problematic, other suspected problematic data may be found through the data DNA relation network, so as to allow the technician to remove or modify the data having quality problem, and improve the quality of the stored data.

### CROSS REFERENCE TO RELATED APPLICATION

The disclosure is a continuation of International Application No. PCT/CN2016/088128, with an international filing date of Jul. 1, 2016, which claims priority to a Chinese Patent Application No. 201510927475.X, entitled “Method And Device For Data Information Processing”, filed with the State Intellectual Property Office of the PRC on Dec. 14, 2015, both of which are incorporated herein by reference in their entireties.

### TECHNICAL FIELD

The present disclosure relates to the field of data information processing, and in particular, to a method and electronic device for data information processing.

### BACKGROUND

Data quality management includes a series of management activities including identification, measurement, monitoring and early warning on various data quality problems which may occur in each phases of data life cycle including planning, acquisition, storage, sharing, maintenance, application and extinction, and data quality can be improved further by improving the management level of the organization.

Currently, in data quality management, massive data is still inputted manually, which may form a relatively sparse distribution of different data. However, in the actual data generation process, there may be some relevance between different data, such that when dealing with massive data, if certain data is found to have quality problem, other data associated with the data having quality problem may not be found effectively in time, which may form potential threats to the data and deteriorate the data quality.

### SUMMARY

In order to solve the above issues in related art, this disclosure provides methods and electronic devices for data information processing.

According to a first aspect of the embodiment of this disclosure, a method for data information processing is provided, the method includes:

Acquiring task logic of data processing when the data is under processing;

Determining input data and output data corresponding to the task logic according to executing logic of the task logic;

Determining data DNA relation information between the input data and the output data; and

With respect to a plurality of stored data, establishing a data DNA relation network among the plurality of stored data according to the data DNA relation information of each of the stored data.

According to a second aspect of the embodiments of the present disclosure, the embodiment of the present disclosure provides a non-volatile computer-readable storage medium stored with computer executable instructions, the computer executable instructions are configured to perform any one of the method described above in the disclosure.

According to a third aspect of the embodiments of the present disclosure, the embodiment of the present disclosure provides an electronic device, including: at least one processor; and a memory; wherein, the memory is communicably connected with the at least one processor for storing instructions executed by the at least one processor, the computer executable instructions are configured to perform any one of the method described above in the disclosure.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a flowchart illustrating a method for data information processing according to an embodiment of the disclosure;

FIG. 2 is a schematic diagram illustrating Step S103 in FIG. 1;

FIG. 3 is a schematic diagram illustrating nodes according to an embodiment of the disclosure;

FIG. 4 is a schematic diagram illustrating a data DNA relation network according to an embodiment of the disclosure;

FIG. 5 is a flowchart illustrating another method for data information processing according to an embodiment of the disclosure;

FIG. 6 is a flowchart illustrating still another method for data information processing according to an embodiment of the disclosure;

FIG. 7 is a schematic diagram illustrating another data DNA relation network according to an embodiment of the disclosure;

FIG. 8 is a structural schematic illustrating a device for data information processing according to an embodiment of the disclosure;

FIG. 9 is a structural schematic illustrating the network establishing module in FIG. 8;

FIG. 10 is a structural schematic illustrating another device for data information processing according to an embodiment of the disclosure; and

FIG. 11 is a structural schematic illustrating still another device for data information processing according to an embodiment of the disclosure;

FIG. 12 is a structural schematic of an electronic device provided by an embodiment of the disclosure.

### DETAILED DESCRIPTION

Embodiments will be illustrated in detail herein, examples of which are illustrated in the drawings. In the following description of the drawings, when regarding the drawings, the same numerals in different drawings represent the same or similar element unless otherwise indicated. The embodiments described in the following embodiments do not represent all embodiments corresponding to the disclosure, but rather, they are examples of the device and method corresponding to some aspects of the disclosure which are described in attached claims.

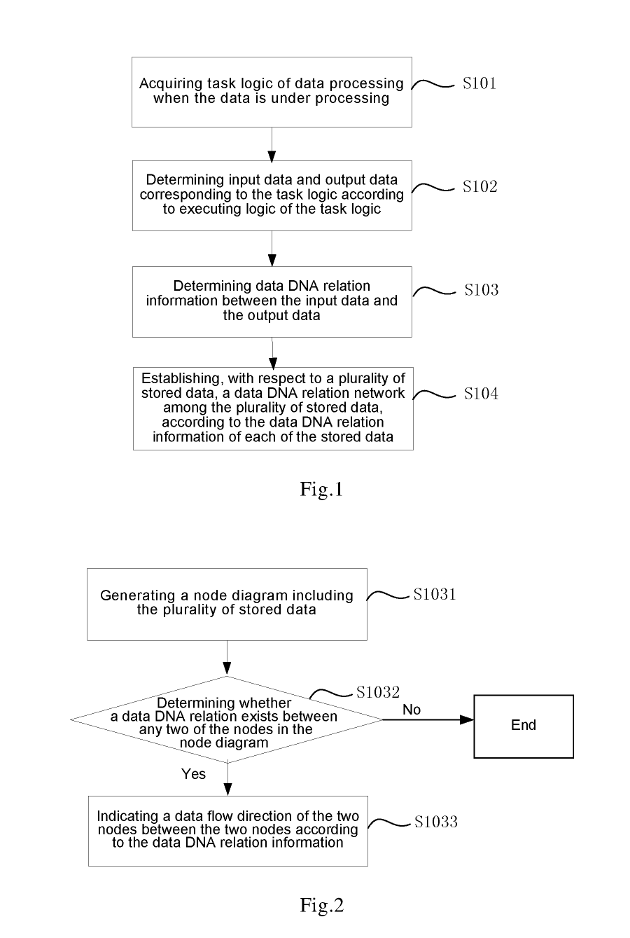

FIG. 1 is a flowchart illustrating a method for data information processing according to an embodiment of the disclosure. The method for data information processing method can be applied in a server. As shown in FIG. 1, the method may include the following steps.

In step S101: task logic of data processing is acquired when the data is under processing.

In different storage media, data may be in different forms. For convenience of description, data is described in a form of data unit in the embodiment of the disclosure. Generally, the output target for each of data processing tasks may be regarded as one data unit. Further, the input source for each of data processing tasks may be regarded as one data unit. For example, in a relational database, each of the cells in a data table may be regarded as one data unit. Additionally, in a front-end display, the report form may be also regarded as one data unit.

Based on the above description, in this step, the task logic for data processing on a data unit may be acquired by taking the data unit as an object.

In the embodiment of the disclosure, the task logic refers to data processing way, such as data format conversion, data operation, etc.

In step S102: input data and output data corresponding to the task logic are determined according to executing logic of the task logic.

Each task logic has executing logic. In the embodiment of the disclosure, the executing logic refers to a flow direction between data. Taking data format conversion as an example, data before format conversion is input data, and data after format conversion is output data. Taking data operation as an example, each of parameters before data operation is input data, and data after data operation is output data.

In step S103: data DNA relation information between the input data and the output data is determined;

Because both the input data and the output data are associated with the same task logic, the output data is acquired after data processing on the input data.

Thus, it can be determined that correlation exists between the input data and the output data.

In the embodiment of the disclosure, data DNA relation information includes at least a data flow direction.

In step S104: with respect to a plurality of stored data, a data DNA relation network among the plurality of stored data is established according to the data DNA relation information of each of the stored data.

For each of the stored data recorded in the server, data DNA relation information corresponding to the stored data can be acquired. In this way, in the process of accumulation of stored data, the data DNA relation information of each of stored data can be acquired simultaneously. The flow direction relation between the stored data can be acquired through the data DNA relation information. Therefore, in this step, on basis of the flow direction relation between the stored data, relations among all stored data can be figured out to acquire the data DNA relation network among the plurality of stored data, that is, a “family tree” among data, a parent node (that is the input data) and a child node (that is the output data) for each of the nodes may be found according to the “family tree”.

The method according to the embodiment of the disclosure may include: acquiring task logic for data processing when the data is under processing; determining input data and output data corresponding to the task logic according to executing logic of the task logic; determining data DNA relation information between the input data and the output data; and establishing, with respect to a plurality of stored data, a data DNA relation network among the plurality of stored data according to the data DNA relation information of each of the stored data.

In this method, for any one of processed data, the input data and the output data associated with the task logic may be determined by acquiring executing logic corresponding to the task logic. Because the task logic exists between the input data and the output data, it may be determined that the input data and the output data have a data DNA relation, and then, for each of the stored data, the data DNA relation among data may be determined through the method, and the data DNA relation network of all stored data may be acquired at last. Further, if certain data in the network is problematic, other suspected problematic data may be found through the data DNA relation network, so as to allow the technician to remove or modify data having quality problem, and improve the quality of the stored data.

In another embodiment of the disclosure, as illustrated in FIG. 2, the step S103 illustrated in the above FIG. 1 may include the following steps.

In step S1031: a node diagram including the plurality of stored data is generated.

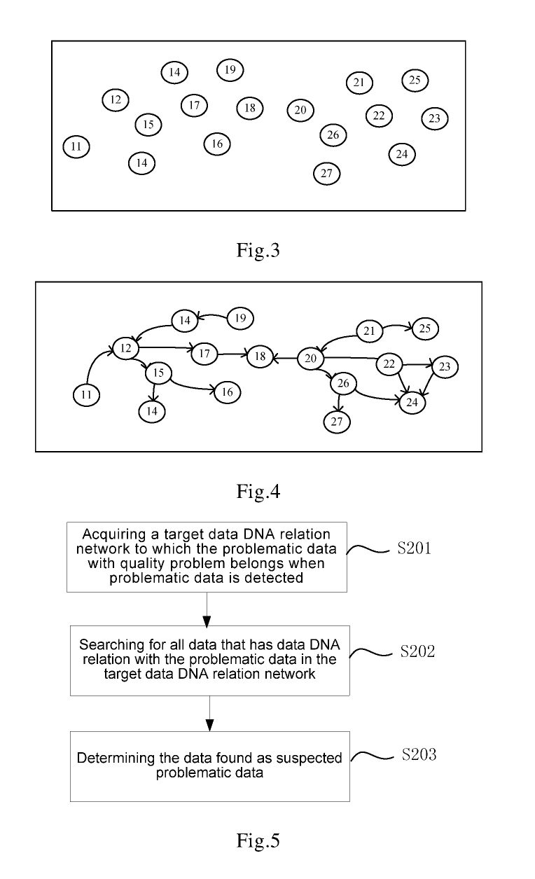

In the embodiment of the disclosure, each of the stored data is presented in form of node in the node diagram. As shown in FIG. 3, each of the circles is a node and represents one datum. Each of the nodes is provided with a numeral corresponding to the data.

In step S1032: whether the data DNA relation exists between any two of the nodes in the node diagram is determined.

In this step, the fact that whether a data DNA relation exists between the two nodes is determined by determining whether the two nodes have task logic.

If the data DNA relation exists between the two nodes, the step S1033 is performed. Otherwise, the process ends.

In step S1033: a data flow direction of the two nodes is indicated between the two nodes according to the data DNA relation information.

As illustrated in FIG. 4, the data flow direction of the two nodes is indicated as arrow between the two nodes, thereby acquiring a data DNA relation network.

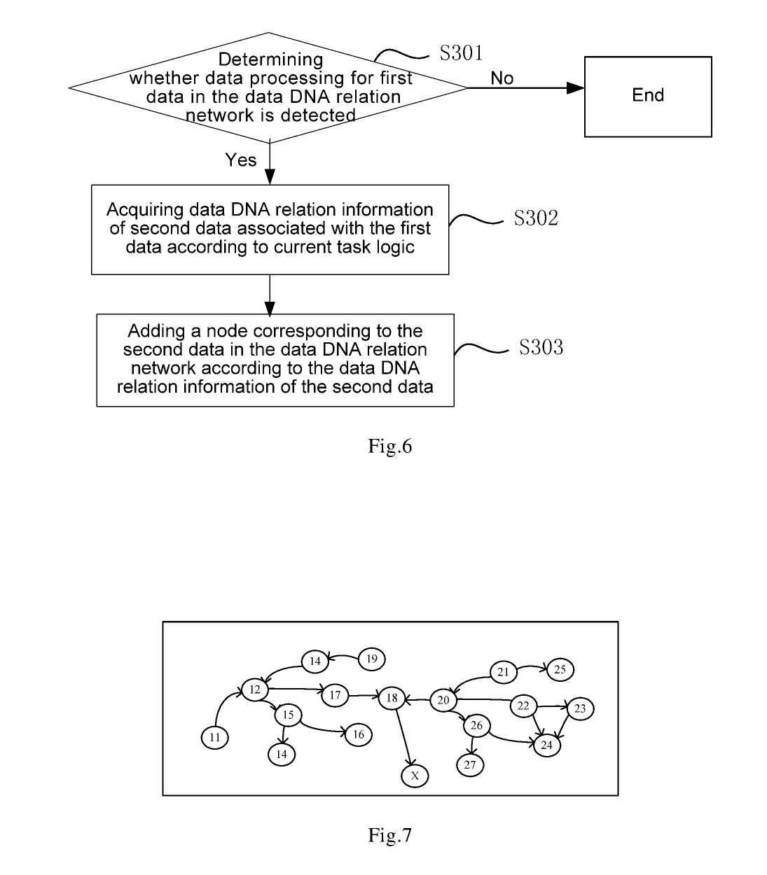

In other embodiment of the disclosure, as illustrated in FIG. 5, after a data DNA relation network for a plurality of stored data is established, the method may further include the following steps.

In step S201: a target data DNA relation network to which problematic data with quality problem belongs is acquired, when the problematic data is detected.

After problematic data with quality problem is detected, a target data DNA relation network to which the problematic data belongs can be found by searching all data DNA relation networks established previously. Taking FIG. 4 above as an example, when the problematic data is the data corresponding to a node 12, the data DNA relation network shown in FIG. 4 may be determined as the target data DNA relation network.

In step S202: all data that has data DNA relation with the problematic data is searched for in the target data DNA relation network;

When the data corresponding to the node 12 in FIG. 4 is the problematic data, all nodes that have task logic with the data are searched for. For example, nodes in FIG. 4 which have direct task logic with the node 12 are: 11, 14 and 15; nodes in FIG. 4 which have indirect task logic with the node 12 are: 14, 16, 17, 18 and 19.

In step S203: the data found is determined as suspected problematic data.

When the node 12 is used as output data, corresponding direct input data may include: a node 11 and a node 14. And with respect to the node 14, a node 19 is the direct input data of the node 14. When the node 12 is used as input data, corresponding direct output data may include: a node 15 and a node 17. And with respect to the node 15, corresponding direct output data may include the node 14 and a node 16; with respect to the node 17, corresponding direct output data may include a node 18.

Once the data corresponding to the node 12 is determined as the problematic data, because both the nodes 11, 14 and 15, and the nodes 14, 16, 17, 18 and 19 are associated with the node 12, these nodes may be regarded as suspected problematic data.

With the method according to the embodiments of the disclosure, in massive stored data, once a certain node is determined to have quality problem, all nodes associated with the node having quality problem can be found as suspected problematic data quickly through the data DNA relation network, so as to quickly locate the data with quality problem, and provide powerful guarantee for the solution of data problems.

In another embodiment of the disclosure, the data corresponding to each of the nodes in the network may also be processed as input data. Accordingly, as shown in FIG. 6, the method may further include the following steps.

In step S301: whether the data processing for first data in the data DNA relation network is detected, is determined.

With respect to data stored in the database, they may be called by the front end and used as the basis of data processing, that is, these stored data is logical operated as input data. Therefore, in this step, whether the data processing for first data in the data DNA relation network is performed, may be detected in real time.

If the data processing for a first data in the data DNA relation network is detected, step S302 is performed; otherwise, the process ends.

In step S302: the data DNA relation information of second data associated with the first data is acquired according to current the task logic.

When the first data as input data is processed, target data obtained after data processing may be regarded as the second data, and then the data DNA relation information between the first data and the second data is acquired.

In step S303: a node corresponding to the second data is added in the data DNA relation network according to the data DNA relation information of the second data.

Taking FIG. 4 as example, when a node 18 is processed as input data, if generated second data is a node x, as shown in FIG. 7, the node x may be added in FIG. 4, and a data flow direction between the node 18 and node x is indicated.

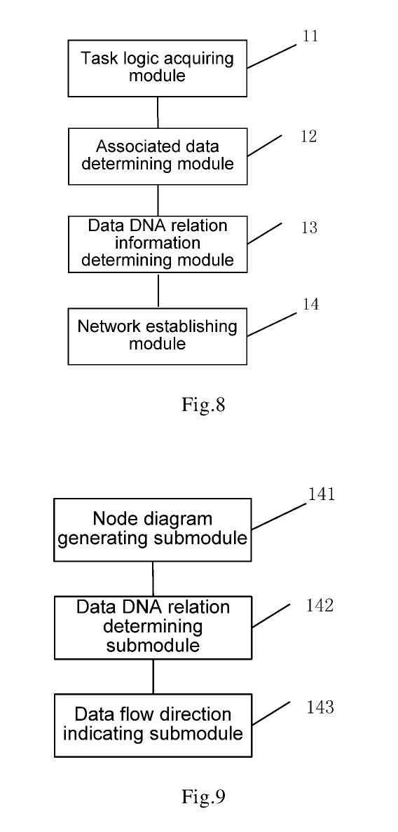

Based on the same inventive conception, an embodiment of the disclosure also provides a device for data information processing. FIG. 8 is a structural schematic illustrating a device for data information processing according to an embodiment of the disclosure. As shown in FIG. 8, the device for data information processing may include: a task logic acquiring module 11, an associated data determining module 12, a data DNA relation information determining module 13 and a network establishing module 14.

The task logic acquiring module 11 acquires task logic of data processing, when the data is under processing.

In different storage media, data may be in different forms. For convenience of description, in the embodiments of the disclosure, the data is described in a form of data unit. Generally, the output target for each of data processing tasks may be regarded as one data unit. Further, the input source for each of data processing tasks may be regarded as one data unit. For example, in a relational database, each of the cells in a data table may be regarded as one data unit. Additionally, in a front-end display, the report form may be also regarded as one data unit.

Based on the above description, in this step, the task logic for data processing on a data unit may be acquired by taking the data unit as an object.

In embodiments of the disclosure, the task logic refers to data processing way, such as: data format conversion, data operation, etc.

The associated data determining module 12 determines input data and output data corresponding to the task logic according to executing logic of the task logic.

Each task logic has executing logic. In the embodiment of the disclosure, the executing logic refers to a flow direction between data. Taking data format conversion as an example, data before format conversion is the input data; data after format conversion is the output data. Taking data operation as an example, each of parameters before data operation may be the input data; and data after data operation is the output data.

The data DNA relation information determining module 13 determines the data DNA relation information of the input data and the output data.

Because both the input data and the output data are associated with the same task logic, the output data is acquired after data processing on the input data. Thus, it can be determined that correlation exists between the input data and the output data.

In the embodiment of the disclosure, the data DNA relation information includes at least a data flow direction.

The network establishing module 14 establishes, with respect to a plurality of stored data, a data DNA relation network among the plurality of stored data, according to the data DNA relation information of each of the stored data.

For each of the stored data recorded in a server, the data DNA relation information corresponding to the stored data can be acquired. As such, in the accumulate process of the stored data, the data DNA relation information of each of stored data can be acquired simultaneously. The flow direction relation between stored data may be acquired through the data DNA relation information. Therefore, in this step, on basis of the flow direction relation between stored data, relations among all stored data can be figured out to acquire the data DNA relation network among the plurality of stored data, that is, a “family tree” among data, the a parent node (that is the input data) and a child node (that is the output data) for each of the nodes may be found through the “family tree”.

In another embodiment of the disclosure, as shown in FIG. 9, the network establishing module 14 in the embodiment of FIG. 8 above may include: a node diagram generating submodule 141, a data DNA relation determining submodule 142 and a data flow direction indicating submodule 143.

The node diagram generating submodule 141 generates a node diagram including the plurality of stored data, each of the stored data is presented in form of node in the node diagram.

In the embodiment of the disclosure, each of the stored data is presented in form of node in the node diagram. As shown in FIG. 3, each of the circles is a node and represents one datum. Each of the nodes is provided with a numeral corresponding to the data.

The data DNA relation determining submodule 142 determines whether a data DNA relation exists between any two of the nodes in the node diagram.

In the embodiment of the disclosure, the fact that whether a data DNA relation exists between the two nodes may be determined by determining whether the two nodes have task logic.

The data flow direction indicating submodule 143 indicates a data flow direction of the two nodes between the two nodes according to the data DNA relation information if a data DNA relation exists between the two nodes.

As illustrated in FIG. 4, the data flow direction of the two nodes is indicated as arrow between the two nodes.

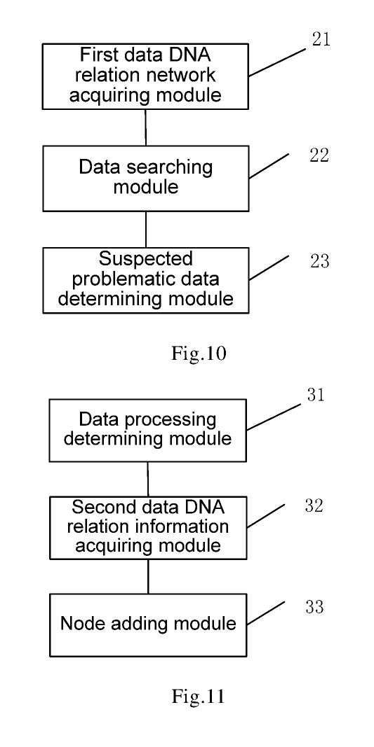

In another embodiment of the disclosure, as shown in FIG. 10, the device for data information processing according to the embodiment of the disclosure may further include: a first data DNA relation network acquiring module 21, a data searching module 22 and a suspected problematic data determining module 23.

The first data DNA relation network acquiring module 21 acquires a target data DNA relation network to which the problematic data with quality problem belongs when the problematic data is detected.

When problematic data with quality problem is detected, the target data DNA relation network to which the problematic data belongs can be found by searching all the data DNA relation networks established previously. Taking FIG. 4 above as an example, when the problematic data is the data corresponding to a node 12, the data DNA relation network shown in FIG. 4 may be determined as the target data DNA relation network.

The data searching module 22 searches for all data that has data DNA relation with the problematic data in the target data DNA relation network.

When the data corresponding to the node 12 in FIG. 4 is the problematic data, all nodes that have task logic with the data may be searched for. For example, nodes in FIG. 4 which have direct task logic with the node 12 are 11, 14 and 15; and nodes in FIG. 4 which have indirect task logic with the node 12 are 14, 16, 17, 18 and 19.

The suspected problematic data determining module 23 determines the data found as suspected problematic data.

When the node 12 is used as output data, corresponding direct input data may include a node 11 and a node 14. And with respect to the node 14, a node 19 is the direct input data of the node 14. When node 12 is used as input data, corresponding direct output data may include a node 15 and a node 17. And with respect to the node 15, corresponding direct output data may include the node 14 and a node 16. With respect to the node 17, corresponding direct output data may include a node 18.

Once the data corresponding to the node 12 is determined as the problematic data, because both the nodes 11, 14 and 15, and the nodes 14, 16, 17, 18 and 19 are associated with the node 12, these nodes may be regarded as suspected problematic data.

With the device according to the embodiment of the disclosure, in massive stored data, once a certain node is determined to have quality problem, all nodes associated with the node having quality problem can be found as suspected problematic data quickly through the data DNA relation network, so as to quickly locate the data with quality problem, and provide powerful guarantee for the solution of data problems.

In still another embodiment of the disclosure, as shown in FIG. 11, the device for data information processing according to the embodiment of the disclosure may further include: a data processing determining module 31, a second data DNA relation information acquiring module 32 and a node adding module 33.

The data processing determining module 31 determines whether data processing for first data in the data DNA relation network is detected.

With respect to data stored in the database, they may be called by the front end and used as the basis of data processing, that is, these stored data is logical operated as the input data. Therefore, in this step, whether the data processing for the first data in the data DNA relation network is performed, may be detected in real time.

The second data DNA relation information acquiring module 32 acquires the data DNA relation information of second data associated with the first data according to current task logic if the data processing for the first data in the data DNA relation network is detected.

When the first data as input data is processed, target data obtained after data processing may be regarded as the second data, and then the data DNA relation information between the first data and the second data is acquired.

The node adding module 33 adds a node corresponding to the second data in the data DNA relation network according to the data DNA relation information of the second data.

Taking FIG. 4 as an example, when a node 18 is processed as input data, if the generated second data is a node x, as shown in FIG. 7, the node x may be added in FIG. 4, and the data flow direction between the node 18 and the node x is indicated.

Embodiments of the present disclosure further provide a non-volatile computer-readable storage medium, the non-volatile computer-readable storage medium is stored with computer executable instructions, the computer executable instructions perform the method for data information processing in any embodiment described above.

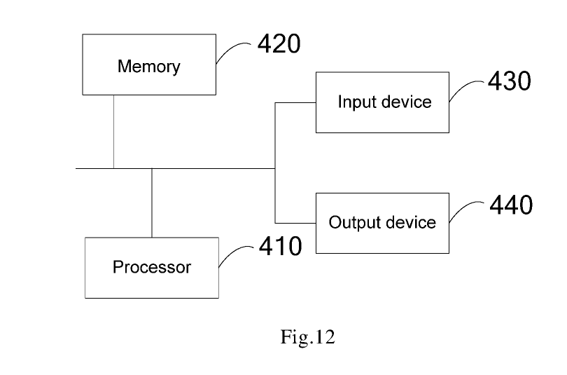

FIG. 12 is a schematic diagram of hardware structure of an electronic device used to perform the method described above according to an embodiment of the present disclosure, as shown in FIG. 12, the device includes:

One or more processors 410 and a memory 420, FIG. 12 illustrates one processor 410 as an example.

The device for the method described above may further include an input device 430 and an output device 440.

The processor 410, the memory 420, the input device 430 and the output device 440 may be connected with each other through bus or other forms of connections. FIG. 12 illustrates bus connection as an example.

As a non-volatile computer-readable storage medium, the memory 420 may store non-volatile software program, non-volatile computer executable program and modules, such as program instructions/modules corresponding to the method described above according to the embodiments of the disclosure (for example, the task logic acquiring module 11, the associated data determining module 12, the data DNA relation information determining module 13 and the network establishing module 14, as illustrated in FIG. 8. By executing the non-volatile software program, instructions and modules stored in the memory 420, the processor 410 may perform various functional applications of the server and data processing, that is, the method described above according to the above mentioned embodiments.

The memory 420 may include a program storage area and a data storage area, wherein, the program storage area may be stored with the operating system and applications which are needed by at least one functions, and the data storage area may be stored with data which is created according to use of the device described above. Further, the memory 420 may include a high-speed random access memory, and may further include non-volatile memory, such as at least one of disk memory device, flash memory device or other types of non-volatile solid state memory device. In some embodiments, optionally, the memory 420 may include memory provided remotely from the processor 410, and such remote memory may be connected with the device described above through network connections, the examples of the network connections may include but not limited to internet, intranet, LAN (Local Area Network), mobile communication network or combinations thereof.

The input device 430 may receive inputted number or character information, and generate key signal input related to the user settings and functional control of the device described above. The output device 440 may include a display device such as a display screen.

The above one or more modules may be stored in the memory 420, when these modules are executed by the one or more processors 410, the method described above according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) Mobile communication device, characterized in having a function of mobile communication mainly aimed at providing speech and data communication, wherein such terminal includes: smart phone (such as iPhone), multimedia phone, functional phone, low end phone and the like;

(2) Ultra mobile personal computer device, which falls in a scope of personal computer, has functions of calculation and processing, and generally has characteristics of mobile internet access, wherein such terminal includes: PDA, MID and UMPC devices, such as iPad;

(3) Portable entertainment device, which can display and play multimedia contents, and include audio or video player (such as iPod), portable game console , E-book and smart toys and portable vehicle navigation device;

(4) Server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) Other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for data information processing, comprising:
at an electronic device:
acquiring task logic of data processing when the data is under processing;
determining input data and output data corresponding to the task logic according to executing logic of the task logic;
determining data DNA relation information between the input data and the output data; and
establishing, with respect to a plurality of stored data, a data DNA relation network among the plurality of stored data, according to the data DNA relation information of each of the stored data.

2. The method according to claim 1, wherein, the data DNA relation information comprises at least: a data flow direction; and
the task logic comprises any one of data format conversion and data operation.

3. The method according to claim 1, wherein the establishing the data DNA relation network among the plurality of stored data comprises:
generating a node diagram comprising the plurality of stored data, each of the stored data being presented in form of node in the node diagram;
determining whether a data DNA relation exists between any two of the nodes in the node diagram; and
indicating a data flow direction of the two nodes between the two nodes according to the data DNA relation information if the data DNA relation exists between the two nodes.

4. The method according to claim 1, further comprising:
acquiring a target data DNA relation network to which problematic data with quality problem belongs when the problematic data is detected;
searching for all data that has data DNA relation with the problematic data in the target data DNA relation network; and
determining the data found as suspected problematic data.

5. The method according to claim 1, further comprising:
determining whether data processing for first data in the data DNA relation network is detected;
acquiring data DNA relation information of second data associated with the first data according to current task logic if the data processing for the first data in the data DNA relation network is detected; and
adding a node corresponding to the second data in the data DNA relation network according to the data DNA relation information of the second data.

6. A non-volatile computer-readable storage medium stored with computer executable instructions that, when executed by an electronic device, cause the electronic device to:
acquire task logic of data processing when the data is under processing;
determine input data and output data corresponding to the task logic according to executing logic of the task logic;
determine data DNA relation information between the input data and the output data; and
establish, with respect to a plurality of stored data, a data DNA relation network among the plurality of stored data, according to the data DNA relation information of each of the stored data.

7. The non-volatile computer-readable storage medium according to claim 6, wherein, the data DNA relation information comprises at least: a data flow direction; and
the task logic comprises any one of data format conversion and data operation.

8. The non-volatile computer-readable storage medium according to claim 6, wherein the establishing the data DNA relation network among the plurality of stored data comprises:
generating a node diagram comprising the plurality of stored data, each of the stored data being presented in form of node in the node diagram;
determining whether a data DNA relation exists between any two of the nodes in the node diagram; and
indicating a data flow direction of the two nodes between the two nodes according to the data DNA relation information if the data DNA relation exists between the two nodes.

9. The non-volatile computer-readable storage medium according to claim 6, wherein, the electronic device is further caused to:
acquire a target data DNA relation network to which problematic data with quality problem belongs when the problematic data is detected;
search for all data that has data DNA relation with the problematic data in the target data DNA relation network; and
determine the data found as suspected problematic data.

10. The non-volatile computer-readable storage medium according to claim 6, wherein, the electronic device is further caused to:
determine whether data processing for first data in the data DNA relation network is detected;
acquire data DNA relation information of second data associated with the first data according to current task logic if the data processing for the first data in the data DNA relation network is detected; and
add a node corresponding to the second data in the data DNA relation network according to the data DNA relation information of the second data.

11. An electronic device, comprising:
at least one processor; and
a memory, communicably connected with the at least one processor for storing instructions executed by the at least one processor,
wherein the execution of the instructions by the at least one processor causes the at least one processor to:
acquire task logic of data processing when the data is under processing;
determine input data and output data corresponding to the task logic according to executing logic of the task logic;
determine data DNA relation information between the input data and the output data; and
establish, with respect to a plurality of stored data, a data DNA relation network among the plurality of stored data, according to the data DNA relation information of each of the stored data.

12. The electronic device according to claim 11, wherein, the data DNA relation information comprises at least: a data flow direction; and
the task logic comprises any one of data format conversion and data operation.

13. The electronic device according to claim 11, wherein the establishing the data DNA relation network among the plurality of stored data comprises:
generating a node diagram comprising the plurality of stored data, each of the stored data being presented in form of node in the node diagram;
determining whether a data DNA relation exists between any two of the nodes in the node diagram; and
indicating a data flow direction of the two nodes between the two nodes according to the data DNA relation information if the data DNA relation exists between the two nodes.

14. The electronic device according to claim 11, wherein, the at least one processor is further caused to:
acquire a target data DNA relation network to which problematic data with quality problem belongs when the problematic data is detected;
search for all data that has data DNA relation with the problematic data in the target data DNA relation network; and
determine the data found as suspected problematic data.

15. The electronic device according to claim 11, wherein, the at least one processor is further caused to:
determine whether data processing for first data in the data DNA relation network is detected;
acquire data DNA relation information of second data associated with the first data according to current task logic if the data processing for the first data in the data DNA relation network is detected; and
add a node corresponding to the second data in the data DNA relation network according to the data DNA relation information of the second data.
